(19) United States
(12) Patent Application Publication
(10) Pub. No.: US 2008/0248340 A1
(43) Pub. Date: Oct. 9, 2008

(54) Fuel cell system

(75) Inventors: Kazunori Fukuma, Saitama (JP); Nobutaka Nakajima, Saitama (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Honda Motor Co., Ltd.

(21) Appl. No.: 12/078,518

(22) Filed: Apr. 1, 2008

(30) Foreign Application Priority Data
Apr. 4, 2007 (JP) 2007-098225

(51) Int. Cl. H01M 8/02

(52) U.S. Cl. 429/13; 429/34

(57) ABSTRACT

The fuel cell system enabling shortening of the startup time of the system and preventing a pressure sensor from malfunctioning is provided. The fuel system 1 includes a fuel cell 10; a hydrogen tank 22 supplying hydrogen gas to the anode side of the fuel cell 10 through a hydrogen supply channel 43; an air pump 21 supplying air to the cathode side of the fuel cell 10 through an air supply channel 41; a bypass 46 connecting the air supply channel 41 with the hydrogen supply channel 43; an air induction valve 461 provided on the bypass 46, enabling control of the amount of gas flowing in the bypass 46; and a pressure sensor 51 having a diaphragm which is deformable by the pressure of the hydrogen gas, the pressure sensor detecting pressure of hydrogen gas by detecting displacement of the diaphragm.

This application is based on and claims the benefit of priority from Japanese Patent Application No. 2007-098225, filed on 4 Apr. 2007, the content of which is incorporated herein by reference.

### BACKGROUND OF THE INVENTION

1. Field of the Invention

The present invention relates to a fuel cell system. More particularly, the present invention relates to the fuel cell system provided with a pressure sensor detecting pressure of anode gas supplied to the fuel cell.

2. Related Art

Recently, fuel cell systems have drawn attention as a new source of power that can be used in motor vehicles. For example, a fuel cell system is provided with a fuel cell producing electric power by chemically reacting anode gas with cathode gas, an anode gas supply unit supplying the anode gas to the fuel cell through an anode gas channel, and a cathode gas supply unit supplying cathode gas to the fuel cell through a cathode gas channel.

The fuel cell can be structured to include a plurality (e.g., tens or hundreds) of stacked cells. In such an example, each cell is configured with a membrane electrode assembly (MEA) held between a pair of separators. The MEA is configured with two electrodes, which are an anode (i.e. a positive electrode) and a cathode (i.e. a negative electrode), and a solid polymer electrolyte membrane held between these electrodes.

Supplying hydrogen gas as anode gas to the anode and oxidation air as cathode gas to the cathode causes an electrochemical reaction by which the fuel cell produces electric power. Since only water, which is essentially harmless to the environment, is generated during power production, the fuel cell has garnered attention from the viewpoint of environmental impact and efficiency of use.

The total power production of such a fuel cell is varied depending on the amount of anode gas to be supplied. Accordingly, a pressure sensor detecting the pressure of the anode gas in the anode supply channel is provided in order to control the amount of anode gas to be supplied based on a pressure value detected by this pressure sensor.

In recent years, thinning the abovementioned membrane has been attempted abovementioned membrane in order to miniaturize the fuel cell. However, the thinner the membrane is, the more water generated at the cathode side by the abovementioned electrochemical reaction leaks out to the anode side through the membrane. Accordingly, the anode supply channel suffers from being humidified continuously, whereby a drop of water may adhere to the pressure sensor. In this situation, water adhered to the pressure sensor freezes when ambient temperature drops below the freezing temperature after the fuel cell stops producing electric power. Afterwards, when the fuel cell attempts to resume electric power production, this causes imperfect functioning of the pressure sensor so that the pressure of the anode gas cannot be detected.

Thus, a fuel cell system in which a pressure sensor provided with a heater has been proposed (for example, see Japanese Unexamined Patent Application, First Publication No. 2005-164538). According to this fuel cell system, water adhered to the pressure sensor is defrosted to prevent the pressure sensor from imperfectly functioning by heating the pressure sensor with a heater.

However, in the abovementioned fuel cell system provided with the heater, there is a problem in that production cost is increased with the increasing number of parts and the complicated structure. In addition, since the fuel cell cannot start unless defrosting condensation is completed, the starting time of the fuel cell system is extended, resulting in possibly deteriorating scaleability thereof. Therefore, there is a need for the fuel cell system that does not require heating by a heater.

### SUMMARY OF THE INVENTION

The object of the present invention is to provide a fuel cell system enabling shortening of a starting time of the system and preventing a pressure sensor from imperfectly functioning.

A fuel cell system according to the present invention is characterized by including a fuel cell (e. g., fuel cell 10) producing electric power by a reaction of anode gas and cathode gas; an anode gas supply means (e. g., hydrogen tank 22) for supplying anode gas to an anode side of the fuel cell through an anode supply channel (e. g., hydrogen supply channel 43); a cathode gas supply means (e. g., air supply channel 41) for supplying cathode gas to a cathode side of the fuel cell through a cathode supply channel (e. g., air pump 21); an anode discharge channel (e. g., hydrogen discharge channel 44) connected to the anode side of the fuel cell in which anode emission gas discharged from the fuel cell flows; an anode reflux channel (e. g., hydrogen reflux channel 45) mixing the anode emission gas discharged in the anode discharge channel with the anode gas flowing in the anode supply channel; a bypass channel (e. g., bypass 46) communicating with the anode supply channel and the cathode supply channel; a flow control means (e. g., air induction valve 461), which is provided in the bypass channel, for enabling control of an amount of gas flowing in the bypass channel; and an anode gas pressure detection means (e. g., pressure sensor 51) having a pressure receiving portion (e. g., diaphragm 511) which is deformable by pressure of the anode gas, the anode gas pressure detection means detecting the pressure of the anode gas by detecting displacement of the pressure receiving portion; in which the anode gas pressure detection means is provided between the flow control means and the anode supply channel of the bypass channel.

According to the present invention, the fuel cell system is provided with the bypass channel communicating with the anode supply channel and the cathode supply channel, in which the bypass channel is provided with the flow control means. When scavenging is performed, the flow control means is opened, and then cathode gas is supplied by the cathode gas supply means. This allows the cathode gas to flow from the cathode supply channel to the anode supply channel through the bypass channel and then to the anode side of the fuel cell, the anode discharge channel, and the anode reflux channel, and to be discharged.

In addition, when electric power is produced with the fuel cell, cathode gas is supplied to the cathode side of the fuel cell through the cathode supply channel with the cathode gas supply means while the flow control means is closed. On the other hand, anode gas is supplied with the anode gas supply means. This anode gas circulates through the anode supply channel, the anode side of the fuel cell, the anode discharge channel, and the anode reflux channel.

In addition, since the anode gas pressure detection means is provided with the bypass channel, the anode gas circulates through the abovementioned channel when the electric power is produced with the fuel cell. The pressure in the bypass channel is equivalent to that in the channel through which the anode gas circulates. Comparing to the case in which the anode gas pressure detection means is provided near the anode side of the fuel cell, there is much less influence of the anode gas, thereby decreasing humidity and resulting in hardly filling with vapor. Thus, the pressure can be measured precisely, and imperfect functioning of the anode gas pressure detection means can be prevented.

On the other hand, when scavenging is performed, the pressure receiving portion of the anode gas pressure detection means can be dried directly with the cathode gas, so that filling with water can be prevented. Thus, the starting time of the system can be shortened and the imperfect functioning of the anode gas pressure detection means can be prevented.

In addition, when compared to the case in which the anode gas pressure detection means is provided on the anode supply channel in a conventional manner, the mounting position of the anode gas pressure detection means only has to be changed. Thus, it is unnecessary to change the structure of the anode gas pressure detection means, resulting in low cost.

In this case, it is preferable that the bypass channel be further provided with an induction means (e.g., guides 513 and 513A) for introducing gas flowing in the bypass channel into the pressure receiving portion.

According to this invention, the fuel cell system is provided with such an induction means. Thus, an amount of gas contacting with the pressure receiving portion directly is increased, and thereby promotes drying of the pressure receiving portion.

In this case, it is preferable that the fuel cell system further include a cathode discharge channel (e. g., air discharge channel 42) connected to the cathode side of the fuel cell, in which cathode emission gas discharged from the fuel cell flows; and a humidification device (e. g., humidifier 24) to provide communication between the cathode supply channel and the cathode discharge channel, in which water is exchanged between the cathode emission gas discharged from the fuel cell and the cathode gas which is to be supplied to the fuel cell, and the bypass channel is connected to the cathode supply channel upstream of the humidification device.

The humidification device collects water included in the cathode gas discharged from the fuel cell, and then adds this collected water to cathode gas which is to be supplied to the fuel cell. Accordingly, in regards to the humidity of the cathode gas which is to be supplied to the fuel cell, the humidity at the upstream side of the humidification device is smaller than that at the downstream side of the humidification device.

Therefore, according to the present invention, the bypass channel is connected to the cathode supply channel at the upstream side of the humidification device. Thus, when scavenging is performed, the cathode gas in a dry state before being humidified in the humidification device flows in the bypass channel, and thereby further promotes drying of the pressure receiving portion.

According to the present invention, the anode gas pressure detection means is provided on the bypass channel. When the electric power is produced by the fuel cell, the anode gas circulates through the anode side of the fuel cell, the anode discharge channel, and the anode reflux channel. The pressure in the bypass channel is equivalent to that in the channel through which the anode gas circulates. In addition, there is extremely little influence of this anode gas, whereby vapor is hardly filled. Therefore, the pressure can be measured precisely. On the other hand, when scavenging is performed, the pressure receiving portion of the anode gas pressure detection means can be dried directly with the cathode gas, so that water can be prevented from being filled therewith. Therefore, the starting time of the system can be shortened, and imperfect functioning of the pressure sensor can be prevented.

### BRIEF DESCRIPTION OF THE DRAWINGS

FIG. 1 is a block diagram of the fuel cell system according to a first embodiment of the present invention;

FIG. 2 is a sectional diagram of the pressure sensor according to the first embodiment of the present invention;

FIG. 3 is a sectional diagram of the pressure sensor according to a second embodiment of the present invention; and

FIG. 4 is a sectional diagram of the pressure sensor according to a third embodiment of the present invention.

### DETAILED DESCRIPTION OF THE INVENTION

The embodiments of the present invention are described below with reference to the accompanying drawings. In order to omit or simplify explanations of the following embodiments, the same elements are indicated by the same numerals.

### First Embodiment

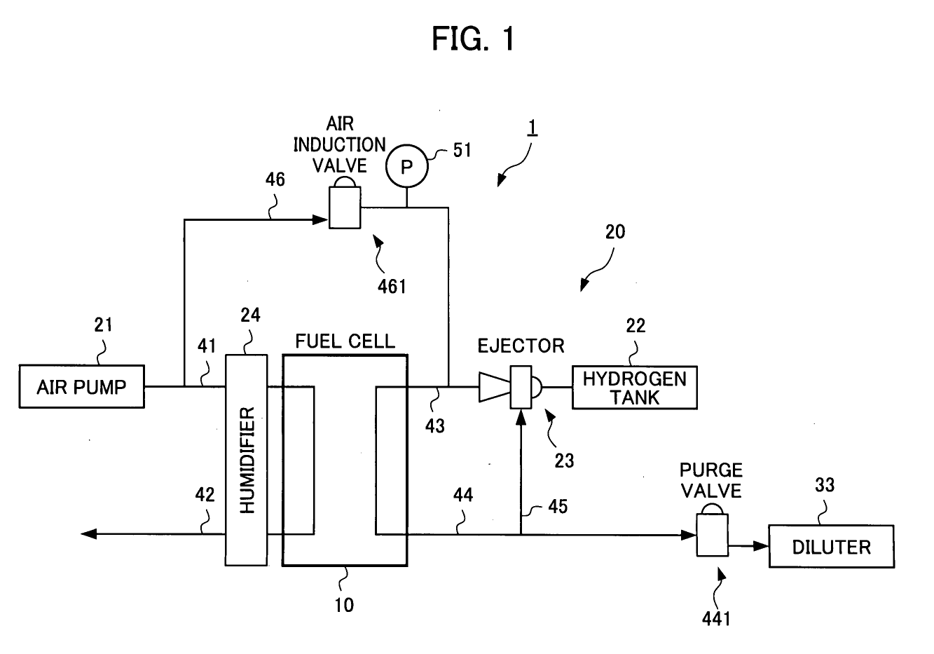

FIG. 1 is a block diagram of the fuel cell system 1 according to the first embodiment of the present invention. The fuel cell system 1 is provided with a fuel cell 10, a supply unit 20 supplying anode and cathode gas to the fuel cell 10.

Supplying hydrogen gas as anode gas to an anode (positive electrode) side and air as a cathode gas to a cathode (negative electrode) side causes an electrochemical reaction by which the fuel cell 10 produces electric power.

The supply unit 20 is configured by an air pump 21 as a cathode gas supply means for supplying air to the cathode side of the fuel cell 10, a hydrogen tank 22 and an ejector 23 as an anode gas supply means for supplying hydrogen gas to the anode side thereof, and a diluter 33 processing gas discharged from the fuel cell 10.

An air discharge channel 42 as a cathode discharge channel is connected to the cathode side of the fuel cell 10. This air discharge channel 42 discharges air utilized in the fuel cell 10. The air discharge channel 42 is connected to the diluter 33.

Then air pump 21 is connected to the cathode side of the fuel cell 10 through an air supply channel 41. The air supply channel 41 is provided with a humidifier 24 as a humidification device. This humidifier 24 collects water included in air flowing in the air discharge channel after having been discharged from the fuel cell, and then adds this collected water to air which is to be supplied to the fuel cell 10, flowing in the air supply channel 41. Accordingly, in regards to a humidity of air which is to be supplied to the fuel cell 10, the humidity at the upstream side of the humidifier 24 is lower than that at the downstream side of the humidifier 24.

The hydrogen tank 22 is connected to the anode side of the fuel cell 10 through a hydrogen supply channel 43 as an anode supply channel. The aforementioned ejector 23 is provided with the hydrogen supply channel 43.

A hydrogen discharge channel 44 as an anode discharge channel is connected to the anode side of the fuel cell 10 and also to the diluter 33. A purge valve 441 is provided near the diluter 33.

By opening this purge valve 441, hydrogen gas in the hydrogen supply channel 43, the hydrogen discharge channel 44, and a hydrogen reflux channel 45 flows into air in the air discharge channel 42 in the diluter 33.

The hydrogen discharge channel 44, which is closer to the fuel cell side than the purge valve 441, is branched to be the hydrogen reflux channel 45 as the anode reflux channel, which connects to the ejector 23.

The ejector 23 collects the hydrogen gas flowing into the hydrogen discharge channel 44 through the hydrogen reflux channel 45 and directs the hydrogen gas to flow back to the hydrogen supply channel 43.

The air supply channel 41 and the hydrogen supply channel 43 are connected to a bypass 46 as the bypass channel. One end of the bypass 46 is connected to the air supply channel 41 at the upstream side of the humidifier 24, i.e. between the air pump 21 and the humidifier 24. The other end of the bypass 46 is connected to the hydrogen supply channel 43 at the fuel cell side 10 rather than the ejector 23. This bypass 46 is provided with an air induction valve 461 as a flow control means. When this air induction valve 461 is opened, gas can flow between the hydrogen supply channel 43 and the air supply channel 41.

In addition, a pressure sensor 51 as the anode gas pressure detection means is provided between the air induction valve 461 and the hydrogen supply channel 43 of the bypass 46.

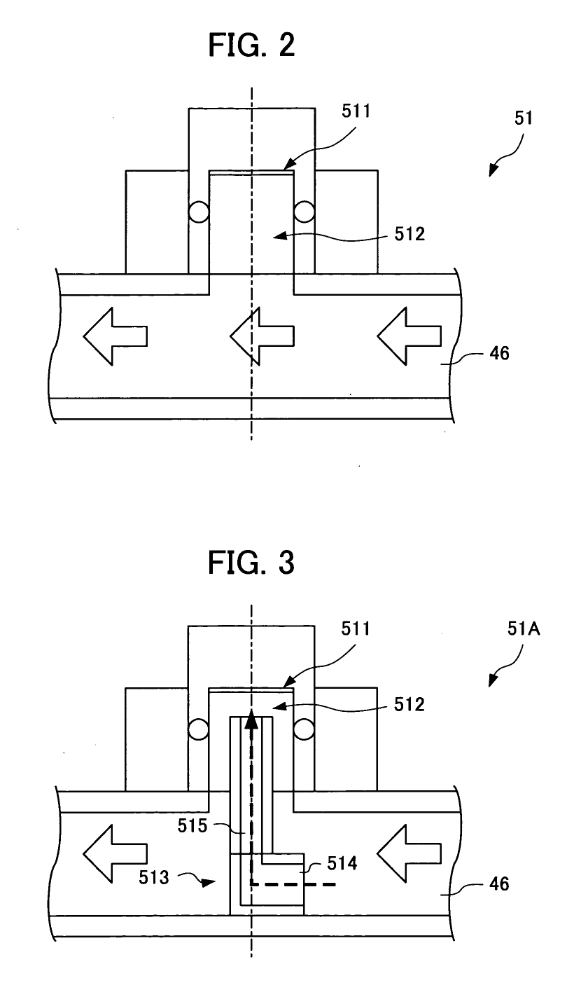

FIG. 2 is a sectional view of the pressure sensor 51.

The pressure sensor 51 is configured with a diaphragm 511 as the pressure receiving portion, and a first chamber 512 and a second chamber (not shown) partitioned by this diaphragm 511.

The first chamber 512 communicates with the bypass 46. The diaphragm 511 disposed to face in a substantially vertically downward direction is deformable by differential pressure between the first chamber 512 and the second chamber.

This pressure sensor 51 detects the internal pressure of the bypass 46 by detecting the displacement of the diaphragm 511.

The procedure to produce electric power by the fuel cell 10 is described below.

Hydrogen gas is supplied from the hydrogen tank 22 to the anode side of the fuel cell 10 through the hydrogen supply channel 43 while the purge valve 441 and the air induction valve 461 are closed. On the other hand, air is supplied to the cathode side of the fuel cell 10 through the air supply channel 41 by driving the air pump 21.

The hydrogen gas and the air supplied to the fuel cell 10 are used for producing the electric power, and then discharged into the hydrogen discharge channel 44 and the air discharge channel 42, respectively. The air discharged into the air discharge channel 42 flows into the diluter 33. On the other hand, since the purge valve 441 is closed, the hydrogen gas discharged in the hydrogen discharge channel 44 flows back to the hydrogen supply channel 43 through the hydrogen reflux channel 45 and the ejector 23 for reuse. Thus, hydrogen gas circulates though the hydrogen supply channel 43, the anode side of the fuel cell 10, the hydrogen discharge channel 44, and then the hydrogen reflux channel 45. The channel through which the hydrogen gas circulates is hereinafter referred to as the hydrogen circulating channel.

In the state in which the purge valve 441 and the air induction valve 461 are closed, the internal pressure of the bypass 46 between the air induction valve 461 and the hydrogen supply channel 43 is equivalent to the internal pressure in the abovementioned hydrogen circulating channel. In addition, the diaphragm 511 of the pressure sensor 51 provided between the air induction valve 461 and the hydrogen supply channel 43 of the bypass 46 is deformed depending on the internal pressure, i.e. the amount of hydrogen in the hydrogen circulating channel.

The procedure to scavenge the fuel cell 10 is described below.

First, the purge valve 461 and the air induction valve 441 are opened, and then the air pump 21 is driven. Then, the air pumped out from the air pump 21 flows through the air supply channel 41, the cathode side of the fuel cell 10, and the air discharge channel 42, and then flows into the diluter 33. Simultaneously, the air flows through the hydrogen supply channel 43, the anode side of the fuel cell 10, the hydrogen discharge channel 44, and the hydrogen reflux channel 45 through the air supply channel 41 and the bypass 46, and then into the diluter 33.

The above-described embodiment of the present invention has the following advantages.

(1) The pressure sensor 51 is provided with the bypass 46.

Accordingly, when the electric power is produced by the fuel cell 10, the hydrogen gas circulates through the hydrogen supply channel 43, the anode side of the fuel cell 10, the hydrogen discharge channel 44, and the hydrogen reflux channel 45. Thus, the pressure of the bypass channel 46 is equivalent to that of the channel through which the hydrogen gas circulates. In addition, in comparison to the case in which the pressure sensor 51 is provided near the anode side of the fuel cell 10, there is much less influence of this hydrogen gas, thereby decreasing the humidity and resulting in being hardly filled with water vapor. Thus, the pressure can be measured precisely, and the imperfect functioning of the pressure sensor 51 can be prevented.

On the other hand, when the scavenge is performed, the diaphragm 511 of the pressure sensor 51 can be dried directly with air, so that water can be prevented from being filled therein. Therefore, the starting time of the system can be shortened, and the imperfect functioning of the pressure sensor can be prevented.

In addition, in comparison to the case in which the pressure sensor 51 is provided in the anode supply channel in a conventional manner, the mounting position of the pressure sensor 51 has only to be changed. Thus, it is unnecessary to change the structure of the pressure sensor 51, resulting in low cost.

When the scavenge is performed, in comparison to the case in which the electric power is produced by the fuel cell 10, the detection accuracy of the internal pressure of the bypass 46, which is detected with the pressure sensor 51, may deteriorate more caused by the air being contacted with the diaphragm 511.

(2) The diaphragm 511 is disposed to face in a substantially vertically downward direction. Accordingly, even if water is adhered to the diaphragm 511, it is easy to drip off by its own weight, thereby preventing the diaphragm 511 from being filled with water.

(3) One end of the bypass 46 is connected to the air supply channel 41 at the upstream side of the humidifier 24, i.e. between the air pump 21 and the humidifier 24. Thus, when the scavenging is performed, air in a dry state before being humidified in the humidifier 24 flows into the bypass 46, thereby further promoting drying of the diaphragm 511.

### Second Embodiment

FIG. 3 is a section view of a pressure sensor 51A according to the second embodiment of the present invention. This embodiment differs from the first embodiment in the way of a guide 513 as the induction means provided inside of the bypass 46.

In other words, the guide 513 is tubular, and is provided with a body 514 extending from the pressure sensor 51A toward the air supply channel side 41 along the bypass 46; and a vertical portion 515 provided on the body 514 and extending toward the diaphragm 511 of the pressure sensor 51A in a substantially vertical direction.

The above-described embodiment of the present invention has the following advantage in addition to the abovementioned.

(4) The tubular guide 513 is provided inside of the bypass 46. Accordingly, air flowing in the bypass 46 also flows in the guide 513, and then is introduced into the diaphragm 511 upon scavenging. Thus, the amount of air directly contacting with the diaphragm 511 is increased, so that drying of the diaphragm 511 can be promoted. Therefore, the time required for this drying can be shortened, and the flux of air required for the drying can be decreased.

### Third Embodiment

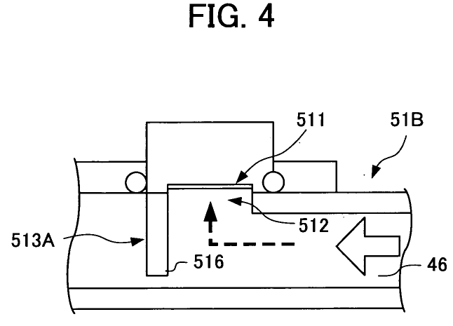

FIG. 4 is a sectional view of a pressure sensor 51B according to the third embodiment of the present invention. This embodiment differs from the second embodiment in the way of the structure of the pressure sensor 51B.

The pressure sensor 51B is provided with a guide 513A, This guide 513A is formed by extending a wall portion 516 of the hydrogen supply channel side 43 of the pressure sensor 51B in a substantially vertically downward direction.

According to the present embodiment, the guide 513A which is the wall portion 516 of the hydrogen supply channel side 43 of the pressure sensor 51B extending in a substantially vertically downward direction in the inside of the bypass 46. Accordingly, air flowing in the bypass 46 upon scavenging contacts with the guide 513A, and then is introduced into the diaphragm 511 thereafter. Therefore, there is an effect similar to that described in (4).

Accordingly, the invention is not to be considered to be limited by the foregoing description, and includes any modifications and changes, etc., within the scope by which the object of the present invention is achieved.

For example, a correction means for correcting a pressure value detected by the pressure sensors 51, 51A, and 51B may be provided. Accordingly, when the electric power is produced with the fuel cell 10, the pressure can be detected precisely by correcting by way of the correction means even if a little of the hydrogen gas flows in the bypass 46.

What is claimed is:

1. A fuel cell system comprising:
a fuel cell producing electric power by a reaction of anode gas and cathode gas;
an anode gas supply means for supplying anode gas to an anode side of the fuel cell through an anode supply channel;
a cathode gas supply means for supplying cathode gas to a cathode side of the fuel cell through a cathode supply channel;
an anode discharge channel connected to the anode side of the fuel cell with anode emission gas discharged from the fuel cell flowing therein;
an anode reflux channel mixing the anode emission gas discharged in the anode discharge channel with the anode gas flowing in the anode supply channel;
a bypass channel communicating with the anode supply channel and the cathode supply channel;
a flow control means provided in the bypass channel for enabling control of an amount of gas flowing in the bypass channel; and
an anode gas pressure detection means having a pressure receiving portion which is deformable by pressure of the anode gas, the anode gas pressure detection means detecting the pressure of the anode gas by detecting displacement of the pressure receiving portion;
wherein the anode gas pressure detection means is provided between the flow control means and the anode supply channel of the bypass channel.

2. The fuel cell system according to claim 1, further comprising: an induction means for introducing gas flowing in the bypass channel to the pressure receiving portion.

3. The fuel cell system according to claim 1, further comprising:
a cathode discharge channel connected to the cathode side of the fuel cell with cathode emission gas discharged from the fuel cell flowing therein; and
a humidification device to provide communication between the cathode supply channel and the cathode discharge channel, the humidification device performing water exchange between the cathode emission gas discharged from the fuel cell and the cathode gas which is to be supplied to the fuel cell;
wherein the bypass channel is connected to the cathode supply channel upstream of the humidification device.

4. The fuel cell system according to claim 1, the pressure receiving portion is disposed to face a substantially vertically downward direction.

5. The fuel cell system according to claim 1, further comprising an induction means for introducing gas flowing in the bypass channel into the pressure receiving portion and provided in the fuel cell system, the induction means including a tubular body extending from the anode gas pressure detection means toward the cathode supply channel side along the bypass channel; and a tubular induction portion provided with the tubular body and extending toward the pressure receiving portion of the anode gas pressure detection means.

6. The fuel cell system according to claim 1, further comprising an induction means for introducing gas flowing in the bypass channel into the pressure receiving portion and provided in the fuel cell system, the induction means being formed by extending a wall portion of the anode supply channel side of the anode gas pressure detection means in a substantially orthogonal direction to the bypass channel.

7. The fuel cell system according to claim 1, further comprising a correction means for correcting a pressure value detected by the anode gas pressure detection means.

8. A method for scavenging a fuel cell system, the fuel cell system comprising a fuel cell producing electric power by a reaction of anode gas and cathode gas;
an anode gas supply means for supplying anode gas to an anode side of the fuel cell through an anode supply channel;
a cathode gas supply means for supplying cathode gas to a cathode side of the fuel cell through a cathode supply channel;
an anode discharge channel connected to the anode side of the fuel cell with anode emission gas discharged from the fuel cell flowing therein;
an anode reflux channel mixing the anode emission gas discharged in the anode discharge channel with the anode gas flowing in the anode supply channel;
a bypass channel communicating with the anode supply channel and the cathode supply channel;
a flow control means provided in the bypass channel, for enabling control of an amount of gas flowing in the bypass channel; and
an anode gas pressure detection means having a pressure receiving portion which is deformable by pressure of the anode gas, the anode gas pressure detection means detecting the pressure of the anode gas by detecting displacement of the pressure receiving portion,
wherein the anode gas pressure detection means is provided between the flow control means and the anode supply channel of the bypass channel, the method comprising:
supplying the cathode gas to the cathode side of the fuel cell through the cathode supply channel and the cathode gas to the anode side of the fuel cell through the cathode supply channel, the bypass channel, and the anode supply channel by driving the cathode gas supply means.
